(19) United States
(12) Patent Application Publication
(10) Pub. No.: US 2003/0233248 A1
(43) Pub. Date: Dec. 18, 2003

(54) Gas turbine intake air filter selecting system

(76) Inventors: Noriya Shingu, Osaka-shi (JP); Mitsuru Dougahara, Osaka-shi (JP); Hidemasa Takashima, Osaka-shi (JP); Shigeru Yoshitake, Osaka-shi (JP)

Correspondence Address: J.C. Patents, Inc., 4 Venture, Suite 250, Irvine, CA, 92618, US

(21) Appl. No.: 10/364,714

(22) Filed: Feb. 10, 2003

(30) Foreign Application Priority Data
Mar. 28, 2002 (JP) 2002-91948

(51) Int. Cl. G06F 17/60

(52) U.S. Cl. 705/1

(57) ABSTRACT

The invention provides a gas turbine intake air filter selecting system that works in accordance with density or nature of dust around a location of an individual gas turbine and with capacity and characteristics of the gas turbine.

A selecting system 20 comprises a catalogue-based sorter 23 for executing a first sorting of filters based on various data extracted from a catalogue data memory unit 21; a life span-based sorter 25 for calculating a filter life span based on various data extracted from a filter use environmental data memory unit 24 and executing a second sorting of filters based on an outcome of the calculation; and a cost-based sorter 27 for calculating an actual cost and an estimated cost respectively based on various data extracted from an actual plant data memory unit 26 and executing a third sorting of filters based on comparison of the actual cost and the estimated cost.

### BACKGROUND OF THE INVENTION

1. Field of the Invention

The present invention relates to a gas turbine intake air filter selecting system, more specifically to a system for selecting an optimum filter to be installed in an air-intake system of a gas turbine.

2. Description of the Related Art

As is popular in the industry, a gas turbine is provided with an intake air filter unit at an upstream side end portion of an intake duct communicating with an internal area of the gas turbine, for collecting fine dust contained in outside air aspirated by an air compressor. Referring to FIG. 9, intake air that has passed through the filter unit 1 is introduced into an air compressor 4 of the gas turbine 3 through an intake duct 2 as shown by the arrows a, after which the intake air passes through a turbine unit 5 and is discharged toward a stack or a heat recovery boiler through an exhaust duct 6 as shown by the arrows b. By the way, reference numeral 7 in FIG. 9 stands for a generator. And the filter unit 1 is usually a two-stage unit provided with a primary filter 11 having a coarse mesh and a secondary filter 12 having a fine mesh, sequentially aligned from an upstream side of the intake air flow.

Under such structure, for the purpose of maintaining a certain performance level of the gas turbine and reducing replacement cost of the filter by restraining filter replacing frequency, it is effective to increase collecting efficiency of the filter and to reduce flow resistance hence pressure loss, thereby achieving a performance level as a high-grade filter unit.

Now, replacing frequency of the gas turbine filter considerably varies depending on a location of a gas turbine, since density or nature of atmospheric dust or dirt (hereinafter referred to as “dust”) naturally varies depending on locations. Therefore, it is necessary to select the most suitable filter for a gas turbine being employed for actual use, through a study on characteristics of individual gas turbines from various viewpoints.

In most of the cases, however, selection of a gas turbine filter (especially for a large-sized gas turbine) has conventionally been performed simply referring to a manufacturer's recommendation or depending on an individual knowledge of a gas turbine user.

In order to properly select a filter under such circumstances, it is necessary for plant manufacturers and users to exactly understand not only density or nature of atmospheric dust in the proximity of a gas turbine but also various characteristics of the gas turbine such as size and capacity, etc.

However since density or nature of dust varies depending on a location of each gas turbine and besides capacity and other characteristics of each gas turbine are different as mentioned already, it is practically unfeasible for plant manufacturers or users to understand all these factors for selecting a filter.

Consequently, despite enormous labor and trouble required for selecting a filter, an optimum filter cannot be properly selected according to characteristics of each gas turbine, which often causes such disadvantages as unreasonably short life span of a filter, increase of filter replacement cost and also increase of gas turbine operating cost.

### SUMMARY OF THE INVENTION

In view of the foregoing problems, it is a technical object of the present invention to provide a gas turbine intake air filter selecting system that works in accordance with density or nature of dust around a location of the gas turbine and with capacity and characteristics of the gas turbine, thereby achieving reduction of filter replacement cost and gas turbine operating cost and prolongation of a life span of the filter.

In order to solve the foregoing technical problem, the invention provides a gas turbine intake air filter selecting system for selecting a filter to be provided in a gas turbine air-intake system for collecting dust, comprising means for sorting by catalogue, for extracting from a catalogue data memory unit at least flow capacity, initial pressure loss and collecting efficiency of filters, and executing a first sorting of filters based on extracted data and performance requirement of each gas turbine; means for sorting by life span with respect to the filters selected by means for sorting by catalogue, for extracting from a filter use environmental data memory unit at least atmospheric dust density, gas turbine operating time and gas turbine compressor intake capacity, calculating a life span of the filters based on data extracted from the environmental data memory unit and the collecting efficiency extracted from the catalogue data memory unit, and executing a second sorting of filters based on an outcome of the calculation; and means for sorting by cost with respect to the filters selected by means for sorting by life span, for extracting from an actual plant data memory unit information related to actual gas turbine operation and information related to actual filter replacement, calculating an actual cost and an estimated cost respectively in relation to use of the filters based on data extracted from the actual plant data memory unit, filter unit price extracted from the catalogue data memory unit and the filter life span, and executing a third sorting of filters based on comparison of the actual cost and the estimated cost.

To describe more briefly, the gas turbine intake air filter selecting system comprises means for sorting by catalogue for executing a first sorting of filters considering required data extracted from a catalogue data memory unit (catalogue database) in which various information of a plurality of filters as a product is stored; means for sorting by life span for filters that have passed the first sorting, for executing a second sorting based on life span considering required data extracted from a memory unit of various data on filter use environment; and means for sorting by cost for filters that have passed the second sorting, for executing a third sorting based on cost of using the filters considering required data extracted from a memory unit of various data on actual plant.

Under such selecting system, means for sorting by catalogue first selects filters depending on whether flow capacity, initial pressure loss and collecting efficiency thereof are in accordance with performance requirement for a filter to be used with a gas turbine owned by a user of filters, following which means for sorting by life span selects filters a life span of which satisfies life span requirement upon calculating based on filter use environmental data such as atmospheric dust density, gas turbine operating time and gas turbine compressor intake capacity as well as the collecting efficiency, therefore a filter that does not affect expected performance level of the gas turbine and has a sufficient life span is selected by an electronic information processor including a computer.

Further following the above, an actual cost and an estimated cost are respectively calculated based on information related to actual gas turbine operation as actual plant data, information related to filter replacement, filter unit price extracted from the catalogue data memory unit and the filter life span, and means for sorting by cost executes a comparison of the actual cost and the estimated cost, thereby to select a filter the estimated cost of which satisfies a required level, therefore a filter that can desirably reduce gas turbine operating cost and filter replacement cost can be selected by, for instance, the foregoing electronic information processor.

Consequently, a filter is finally selected that accords with density or nature of dust of a location of an individual gas turbine and capacity and characteristics of the gas turbine and that can prolong a life span and reduce cost, without depending on a plant manufacturer's suggestion or personal knowledge of a user of the gas turbine.

In such gas turbine intake air filter selecting system, it is preferable that the catalogue data memory unit further stores data of filter dimensions, collecting capacity and collecting efficiency by dust particle size, that the filter use environmental data memory unit further stores data of atmospheric dust distribution by particle size and number of filters installed, and that the actual plant data memory unit stores data of actual electric energy production, gas turbine operating time, fuel unit price, thermal efficiency, fuel calorific value, filter replacing frequency, filter discard cost and number of filters installed.

Also, it is preferable that the actual cost is a total of an actual filter replacement cost calculated based on filter replacing frequency, filter discard cost and number of filters installed extracted from the actual plant data memory unit and a filter unit price extracted from the catalogue data memory unit, and an actual plant operating cost calculated based on electric energy production, fuel unit price, thermal efficiency and fuel calorific value extracted from the actual plant data memory unit.

Further, it is preferable that the estimated cost is a total of an estimated filter replacement cost calculated based on said filter life span, number of filters installed, filter discard cost and gas turbine operating time extracted from the actual plant data memory unit and a filter unit price extracted from the catalogue data memory unit, and an estimated plant operating cost calculated based on electric energy production, fuel unit price, thermal efficiency and fuel calorific value extracted from the actual plant data memory unit.

### BRIEF DESCRIPTION OF THE DRAWINGS

FIG. 1 is a block diagram showing a constitution of a gas turbine intake air filter selecting system according to the embodiment of the present invention;

FIG. 2 is a flow chart showing an operation process of the gas turbine intake air filter selecting system;

FIG. 3 is a flow chart showing an operation process of the gas turbine intake air filter selecting system;

FIG. 4 is a flow chart showing an operation process of the gas turbine intake air filter selecting system;

FIGS. 5(a) to 5(c) are explanatory tables for explaining operation of the gas turbine intake air filter selecting system;

FIGS. 6(a) to 6(f) are explanatory tables for explaining operation of the gas turbine intake air filter selecting system;

FIGS. 7(a) to 7(f) are explanatory tables for explaining operation of the gas turbine intake air filter selecting system;

FIGS. 8(a) to 8(f) are explanatory tables for explaining operation of the gas turbine intake air filter selecting system; and

FIG. 9 is a schematic side view of a gas turbine (plant) for showing flow of intake air passing through filters.

### DESCRIPTION OF THE PREFERRED ENBODIMENTS

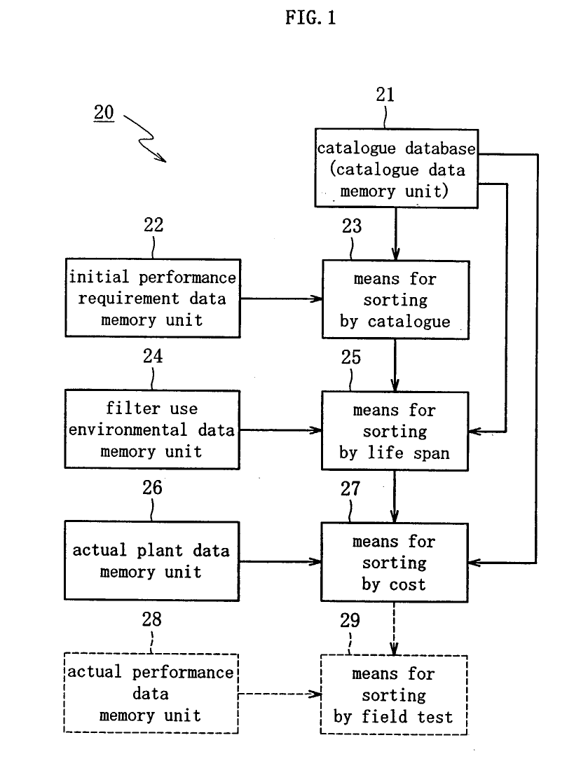

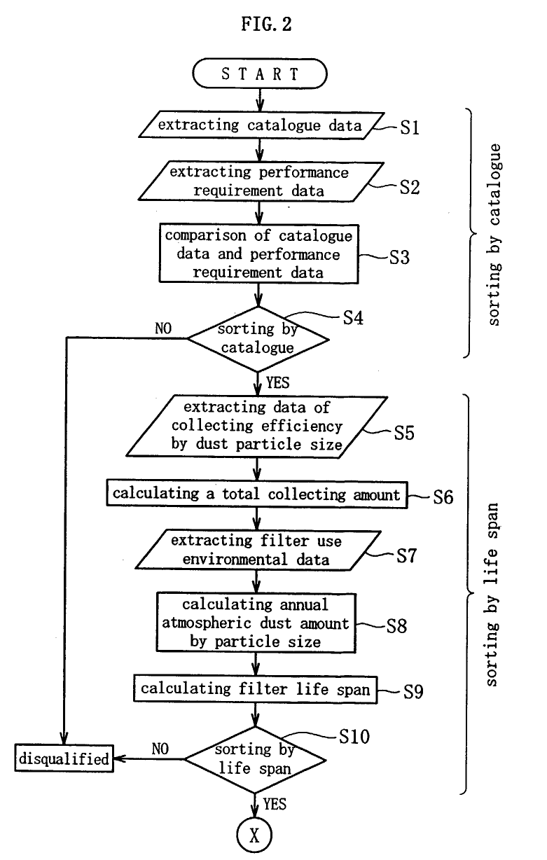

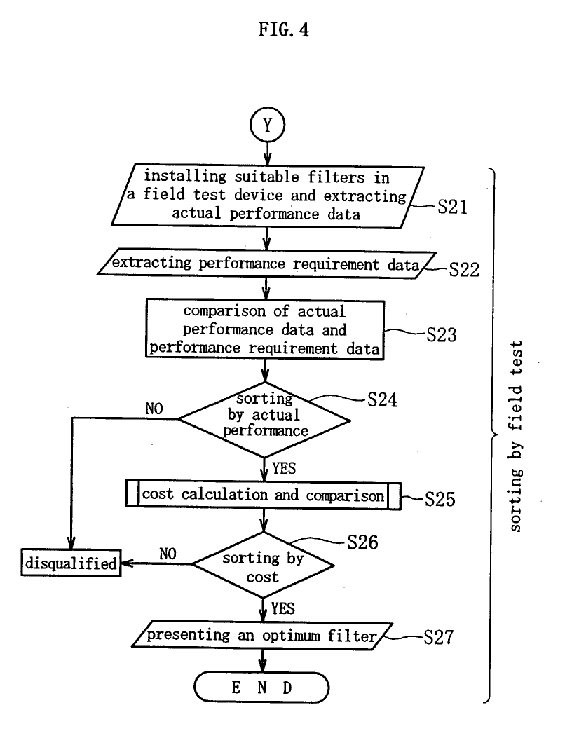

An embodiment of the present invention shall be described hereunder referring to the accompanying drawings. FIG. 1 is a schematic drawing (block diagram) showing a constitution of a gas turbine intake air filter selecting system (hereinafter simply referred to as “selecting system”) according to the embodiment of the invention, and FIGS. 2 to 4 are flow charts showing operation process of the selecting system.

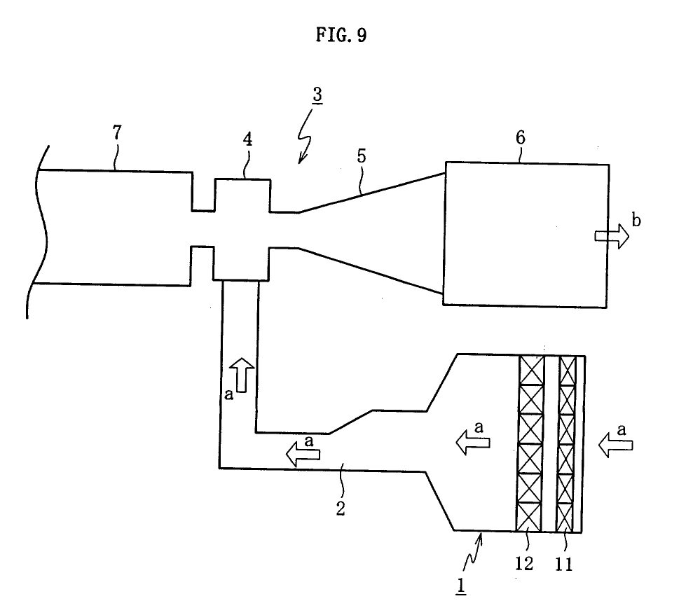

The selecting system 20 of FIG. 1 according to this embodiment serves for selecting filters 11 and 12 in a filter unit 1 attached to an intake duct 2 of a gas turbine 3 shown in FIG. 9, and is constituted of electronic information processors including a computer.

As shown in FIG. 1, the selecting system 20 comprises means for sorting by catalogue 23 for executing a first sorting of filters based on comparison of required data extracted from a catalogue database 21 and required data extracted from an initial performance requirement data memory unit 22; means for sorting by life span 25 for executing a second sorting of filters among a plurality of filters selected by means of sorting by catalogue 23, by calculating the filter life span based on required data extracted from filter use environmental data memory unit 24 and required data extracted from the catalogue database 21; and means for sorting by cost 27 for executing a third sorting of filters among the filters selected by means for sorting by life span 25, by calculating an actual cost and an estimated cost based on required data extracted from an actual plant data memory unit 26 and required data extracted from the catalogue database 21. In addition, the selecting system 20 comprises means for sorting by field test 29 for executing a fourth sorting of filters among the filters selected by means for sorting by cost 27, utilizing a field test device with reference to required data extracted from an actual performance requirement data memory unit 28.

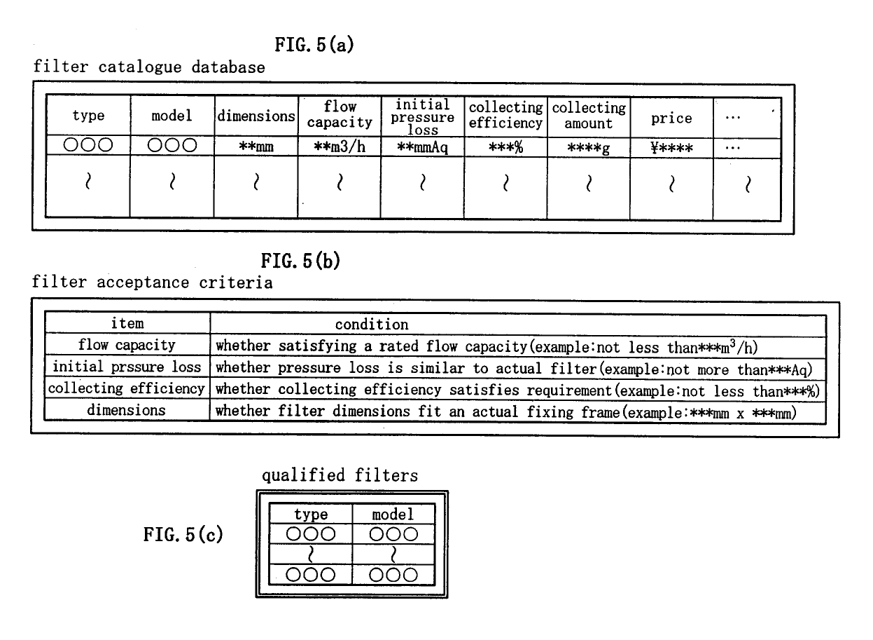

More specifically, the catalogue database 21 stores various performance data of a plurality (a multitude) of filters such as type, model, dimensions, flow capacity, initial pressure loss, collecting efficiency, collecting efficiency by dust particle size, collecting capacity and price (filter unit price), etc, as shown in FIG. 5(a). Also, the initial performance requirement data memory unit 22 stores various performance data required by a gas turbine in relation to the filters, such as flow amount of the gas turbine, actual pressure loss of filters, required collecting efficiency, filter dimensions determined by an actual filter fixing frame, etc. And means for sorting by catalogue 23 extracts flow capacity, initial pressure loss, collecting efficiency and dimensions of filters from the catalogue database 21 and also extracts the above-cited data from the initial performance requirement data memory unit 22, while means for sorting by life span 25 extracts data of collecting efficiency (collecting efficiency by dust particle size) of filters from the catalogue database 21 and means for sorting by cost 27 extracts data of filter unit price from the catalogue database 21.

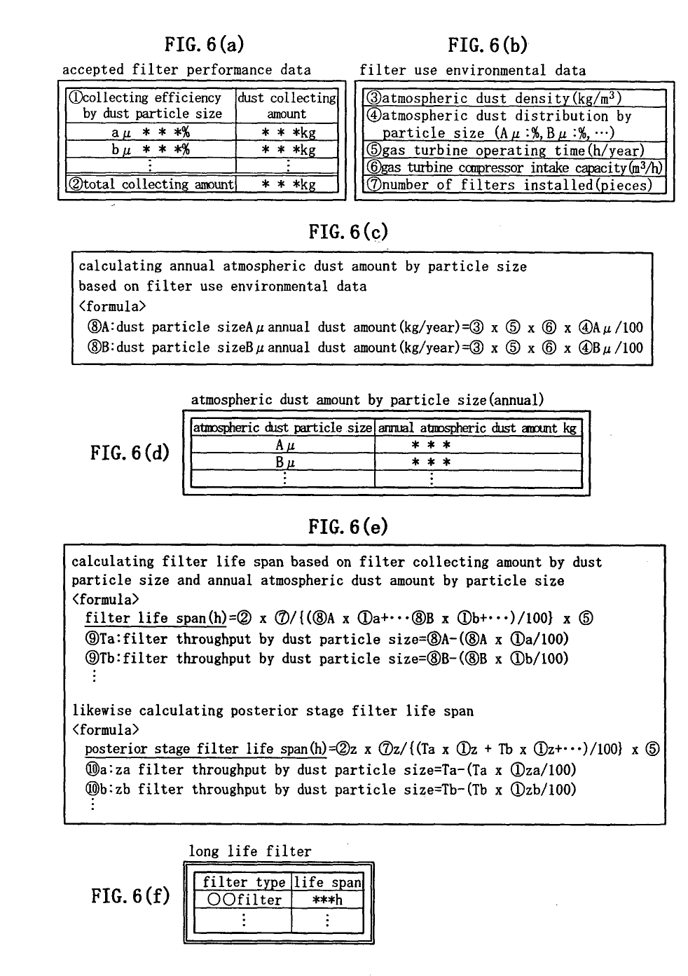

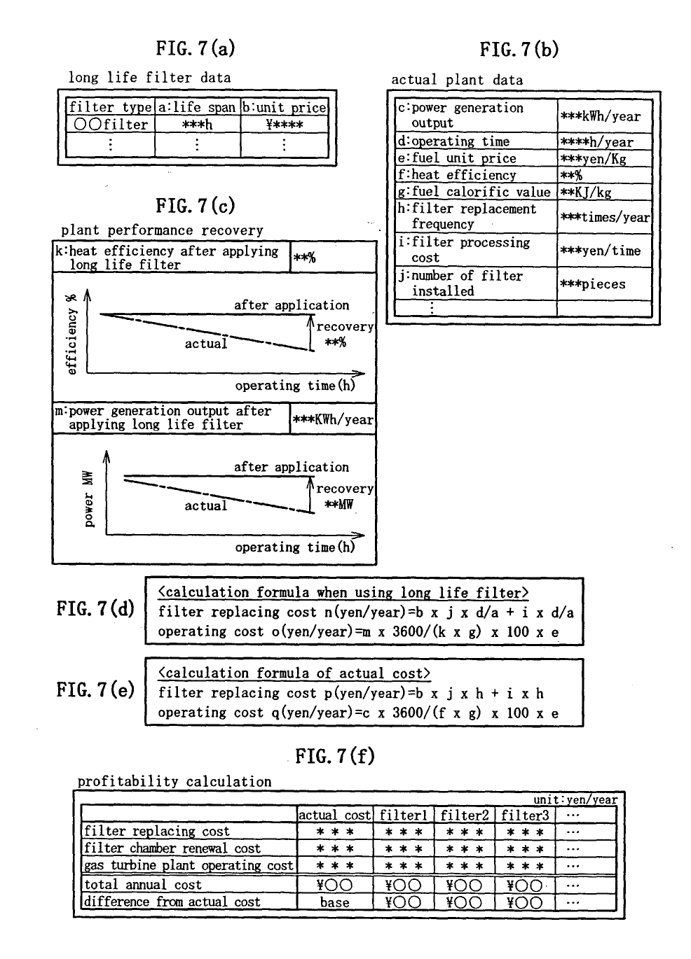

Further, the filter use environmental data memory unit 24 stores various data showing environment in which filters are to be used, such as atmospheric dust density, atmospheric dust distribution by particle size, gas turbine operating time, gas turbine compressor intake capacity and number of filters installed, etc. as shown in FIG. 6(b). And each data stored in the filter use environmental data memory unit 24 is to be extracted by means of sorting by life span 25. Also, the actual plant data memory unit 26 stores various data related to actual situations of the gas turbine such as electric energy production, operating time, fuel unit price, thermal efficiency, fuel calorific value, filter replacement frequency, filter discard cost and number of filters installed, etc. as shown in FIG. 7(b). And such data stored in the actual plant data memory unit 26 can be extracted by means of sorting by cost 27. Further, the actual performance requirement data memory unit 28 stores various filter performance data required at a field test, such as filter life span, pressure loss, collecting efficiency, etc. And each data stored in the actual performance requirement data memory unit 28 is to be extracted by means for sorting by field test 29.

Now referring to flow charts shown in FIGS. 2 to 4, operating process of the selecting system (for example operation of a control unit of the aforementioned electronic information processor) shall be described hereunder.

Firstly, means for sorting by catalogue 23 extracts flow capacity, initial pressure loss, collecting efficiency and dimensions of filters from catalogue database 21 at a step S1 in the flow chart shown in FIG. 2, and also extracts rated flow capacity of a gas turbine, actual filter pressure loss, required collecting efficiency and filter dimensions determined by an actual filter fixing frame from the initial performance requirement data memory unit 22 at a step S2, and compares the mutually corresponding data that has been extracted at a step S3. And a first sorting by catalogue data is executed at a step S4 as shown in FIG. 5(b), by judging whether or not flow capacity of a filter is within a required range based on rated flow capacity of the gas turbine, whether or not initial pressure loss of a filter is similar to that of an actual filter, whether or not collecting efficiency of a filter is within a collecting efficiency range required by the gas turbine, and whether or not filter dimensions are within a range determined by an actual filter fixing frame.

Then with respect to a plurality of filters that have been selected as acceptable (qualified filters of FIG. 5(c)) as a result of the first sorting, means for sorting by life span 25 extracts collecting efficiency by dust particle size \mathring{1} shown in FIG. 6(a) from the catalogue database 21 at a step S5 of the flow chart and calculates a total collecting capacity \mathring{2} at a step S6. Further, atmospheric dust density \mathring{3}, atmospheric dust distribution by particle size \mathring{4}, gas turbine operating time \mathring{5}, gas turbine compressor intake capacity and number of filters installed \mathring{7} are extracted from the filter use environmental data memory unit 24 (ref. FIG. 6(b)) at a step S7, and an annual atmospheric dust amount \mathring{8} by particle size is calculated by a prescribed formula shown in FIG. 6(c) and an outcome of the calculation is preserved (ref. FIG. 6(d)), at a step S8. In this case, the annual atmospheric dust amount \mathring{8} of the respective particle size ranges (Aμ, Bμ, . . . ), which is shown in FIG. 6(c), is calculated by the following formula (1) in which a particle size of Aμ is used as example:

Aμ annual atmospheric dust amount \mathring{8} (kg/year)=atmospheric dust density \mathring{3} (kg/m³)×gas turbine operating time \mathring{5} (h/year)×gas turbine compressor intake capacity \mathring{6} (m³/h)×Aμ atmospheric dust distribution by particle size \mathring{4} (%)/100 . . . (1)

Following the above, a filter life span is calculated at a step S9 of the flow chart, by a prescribed formula shown in FIG. 6(e). In this case, a life span (h) of a filter installed in an anterior stage of a two-stage or three-stage filter unit is calculated by the following formula (2) as also shown in FIG. 6(e). By the way, number of filters installed \mathring{7} in the following formula (2) stands for number of filters for each of the stages.

Anterior stage filter life span (h)=total collecting capacity per filter \mathring{2} (kg)×number of filters installed \mathring{7}/{(Aμ annual atmospheric dust amount \mathring{8} (kg/year)×aμ collecting efficiency by dust particle size \mathring{1} (%)+Bμ annual atmospheric dust amount \mathring{8} (kg/year)×bμ collecting efficiency by dust particle size \mathring{1} (%)+ . . . )/100}×gas turbine operating time \mathring{5} (h/year) . . . (2)

Also, a dust throughput of an anterior stage filter by particle size (kg) is calculated by the following formulas (2)′, (2)″, . . . as also shown in FIG. 6(e).

Aμ filter throughput by dust particle size \mathring{9} (kg)=Aμ annual atmospheric dust amount \mathring{8} (kg/year)−{Aμ annual atmospheric dust amount \mathring{8} (kg/year)×aμ collecting efficiency by dust particle size \mathring{1} (%)/100} . . . (2)′

Bμ filter throughput by dust particle size \mathring{9} (kg)=Bμ annual atmospheric dust amount \mathring{8} (kg/year)−{Bμ annual atmospheric dust amount \mathring{8} (kg/year)×bμ collecting efficiency by dust particle size \mathring{1} (%)/100} . . . (2)″

Further, a life span (h) of a posterior stage filter is calculated by the following formula (3) as also shown in FIG. 6(e).

Posterior stage filter life span (h)=total collecting capacity per filter \mathring{2} (kg)×number of filters installed \mathring{7}/{(anterior stage filter Aμ throughput by dust particle size \mathring{9} (kg)×posterior stage filter Aμ collecting efficiency by dust particle size \mathring{1} (%)+anterior stage filter Bμ throughput by dust particle size \mathring{9} (kg)×posterior stage filter Bμ collecting efficiency by dust particle size \mathring{9} (%) . . . )/100}×gas turbine operating time \mathring{5} (h/year) . . . (3)

Also, a dust throughput of a posterior stage filter by particle size (kg) is calculated by the following formulas (3)′, (3)″, . . . as also shown in FIG. 6(e).

Posterior stage filter Aμ throughput by dust particle size (kg)=anterior stage filter Aμ throughput by dust particle size \mathring{9} (kg)−{anterior stage filter Aμ throughput by dust particle size \mathring{9} (kg)×posterior stage filter Aμ collecting efficiency by dust particle size \mathring{1} (%)/100} (3)′

Posterior stage filter Bμ throughput by dust particle size (kg)=anterior stage filter Bμ throughput by dust particle size \mathring{9} (kg)−{anterior stage filter Bμ throughput by dust particle size \mathring{9} (kg)×posterior stage filter Bμ collecting efficiency by dust particle size \mathring{1} (%)/100} (3)″

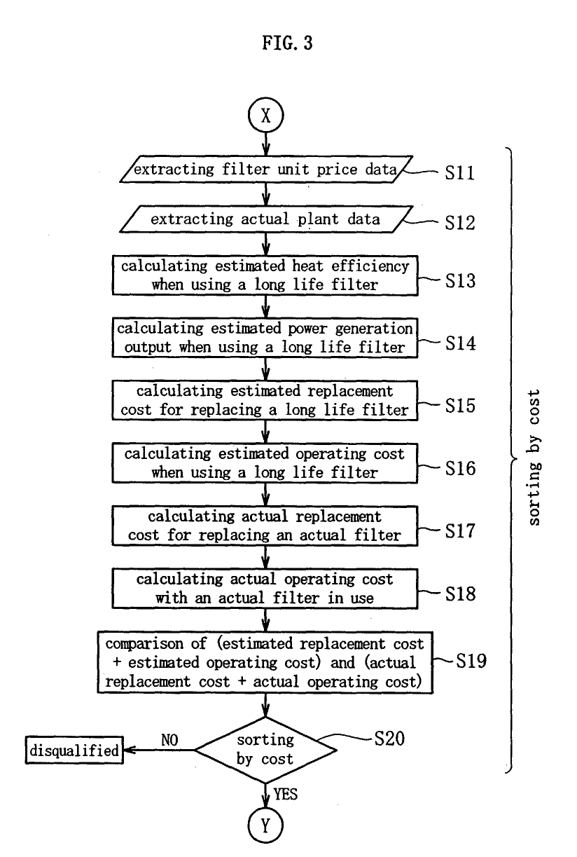

The above is followed by a step S10 of the flow chart, at which it is judged whether the filter life span (h) calculated as above satisfies a required life span, and means for sorting by cost 27 extracts from the catalogue database 21 filter unit prices b of the long life filters shown in FIG. 6(f) that have been selected, at a step S11 of the flow chart shown in FIG. 3. The filter unit prices b are extracted with respect to the long life filters selected as above, and a long life filter data is established by combining the life span a (h) of each of the long life filters and the respective unit prices b thereof (yen), as shown in FIG. 7(a).

Now, electric energy production c, operating time d, fuel unit price e, thermal efficiency f, fuel calorific value g, filter replacement frequency h, filter discard cost i and number of filters installed j are extracted from the actual plant data memory unit 26 (ref. FIG. 7(b)) at a step S12 of the flow chart. And estimated thermal efficiency k when using the long life filter is calculated at a step S13 and then estimated electric energy production m when using the long life filter is used is calculated at a step S14. The estimated thermal efficiency k can be obtained by a conversion utilizing as an index the actual thermal efficiency f that has been extracted on the assumption that the thermal efficiency does not vary with the lapse of operating time when the long life filter is used, as shown in FIG. 7(c). Also, the estimated electric energy production m can be obtained by a conversion utilizing as an index the actual electric energy production c that has been extracted on the assumption that the electric energy production does not vary with the lapse of operating time when the long life filter is used, as shown in FIG. 7(c).

Then a step S15 of the flow chart follows at which an estimated replacement cost n of the long life filter, i.e. an estimated cost required for replacing the long life filter is calculated, and at a step S16 an estimated operating cost o when using the long life filter, i.e. an operating cost of the gas turbine (plant) required when the long life filter is used is calculated. In this case, the estimated replacement cost n and the estimated operating cost o are respectively calculated by the following formulas (4)′ and (4)″, as also shown in FIG. 7(d).

Estimated replacement cost n (yen/year)={filter unit price b (yen)×number of filters installed j (pieces)×operating time d (h/year)/filter life span a (h)}+{filter discard cost i (yen/time)×operating time d (h/year)/filter life span a (h)} (4)′

Estimated operating cost o (yen/year)={estimated electric energy production m (KWh/year)×3600}/estimated thermal efficiency k (%)×fuel calorific value g (KJ/kg)}×100×fuel unit price e (yen/Kg) (4)″

Further, an actual replacement cost p of an actual filter, i.e. an actual cost required for replacing the actual filter is calculated at a step S17 of the flow chart, and an actual operating cost q with the actual filter, i.e. an operating cost of the gas turbine (plant) required with the actual filter in use is calculated at a step S18. In this case, the actual replacement cost p and the actual operating cost q are respectively calculated by the following formulas (5)′ and (5)″, as also shown in FIG. 7(e).

Actual replacement cost p (yen/year)={actual filter unit price b (yen)×number of filters installed j (pieces)×filter replacement frequency h (times/year)}+{filter discard cost i (yen/time)×filter replacement frequency h (times/year)} (5)′

Actual operating cost q (yen/year)={actual electric energy production c (KWh/year)×3600}/actual thermal efficiency f (%)×fuel calorific value g (KJ/kg)}×100×fuel unit price e (yen/Kg) (5)″

Upon completing the foregoing calculations, a total amount of the estimated replacement cost n and the estimated operating cost o is compared with a total amount of the actual replacement cost p and the actual operating cost q at a step S19 of the flow chart. In this comparison, for example a filter chamber renewal cost is taken into account as shown in FIG. 7(f).

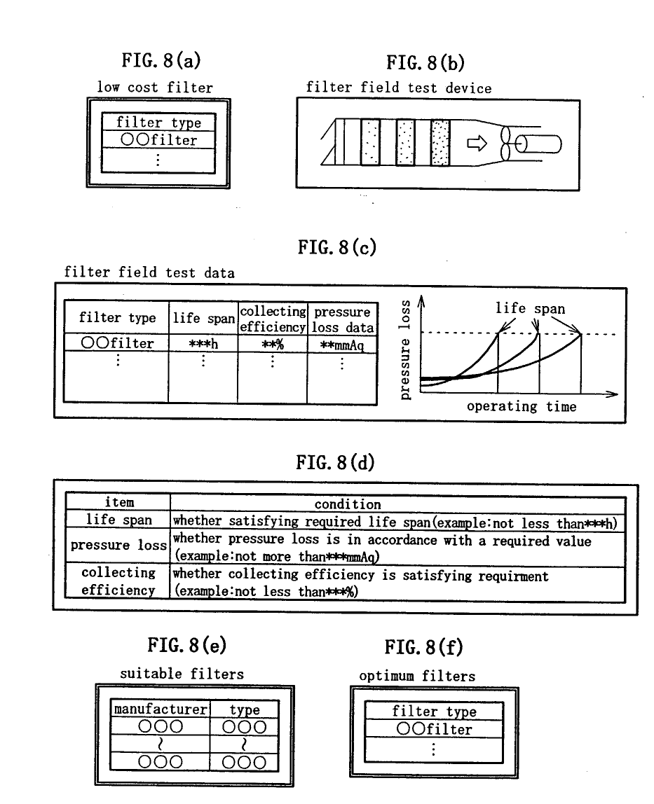

Then at a step S20 of the flow chart acceptability of cost is judged according to whether the total amount of the estimated replacement cost n and the estimated operating cost o is as much lower than the total amount of the actual replacement cost p and the actual operating cost q as to satisfy a required cost, and means for sorting by field test 29 executes the following process with filters that have been selected, i.e. low cost filters shown in FIG. 8(a).

Specifically, means for sorting by field test 29 extracts filter life span, collecting efficiency and pressure loss at a step S21 as shown in FIG. 8(c) as test data for a field test device in which the low cost filters are installed for example in three stages as shown in FIG. 8(b), and extracts filter life span, collecting efficiency and pressure loss as performance data required for the test, at a step S22. Then each item of the test data (actual performance data) and the required performance data is compared at a step S23, and acceptability of the actual performance data by the test is judged at a step S24. To be more detailed, it is judged whether or not the filter life span of the test data satisfies the required life span, whether or not the collecting efficiency of the test data satisfies the required collecting efficiency and whether or not the pressure loss of the test data is in accordance with a required value, as shown in FIG. 8(d).

With respect to filters selected as acceptable, i.e. suitable filters shown in FIG. 8(e), filter replacement cost and operating cost expended at the field test and required filter replacement cost and operating cost are calculated and compared at a step S25 of the flow chart in a similar method to the steps S15 through S19, and acceptability of the cost by the field test is judged at a step S26. And then at a step S27, filters that have been selected as acceptable are finally presented as optimum filters shown in FIG. 8(f).

As described above, since a gas turbine intake air filter selecting system according to the invention comprises means for sorting by catalogue for executing a first sorting of filters based on various data extracted from a catalogue data memory unit; means for sorting by life span for calculating a filter life span based on various data extracted from a filter use environmental data memory unit and executing a second sorting of filters based on an outcome of the calculation; and means for sorting by cost for calculating an actual cost and an estimated cost respectively based on various data extracted from an actual plant data memory unit and executing a third sorting of filters based on comparison of the actual cost and the estimated cost, a filter can finally be selected that accords with density or nature of dust of a location of an individual gas turbine and capacity and characteristics of the gas turbine and that can prolong a life span and reduce running cost, without depending on a plant manufacturer's suggestion or personal knowledge of a user of the gas turbine.

What is claimed is:

1. A gas turbine intake air filter selecting system for selecting a filter to be provided in a gas turbine air-intake system for collecting dust, comprising:
means for sorting by catalogue, for extracting from a catalogue data memory unit at least flow capacity, initial pressure loss and collecting efficiency of filters, and executing a first sorting of filters based on extracted data and performance requirement of each gas turbine;
means for sorting by life span with respect to said filters selected by said means for sorting by catalogue, for extracting from a filter use environmental data memory unit at least atmospheric dust density, gas turbine operating time and gas turbine compressor intake capacity, calculating a life span of a filter based on data extracted from said environmental data memory unit and said collecting efficiency extracted from said catalogue data memory unit, and executing a second sorting of filters based on an outcome of said calculation; and
means for sorting by cost with respect to said filters selected by said means for sorting by life span, for extracting from an actual plant data memory unit information related to actual gas turbine operation and information related to actual filter replacement, calculating an actual cost and an estimated cost respectively in relation to use of said filters based on data extracted from said actual plant data memory unit, unit price of said filter extracted from said catalogue data memory unit and said life span of said filters, and executing a third sorting of filters based on comparison of said actual cost and said estimated cost.

2. The gas turbine intake air filter selecting system as set forth in claim 1, wherein said catalogue data memory unit further stores data of filter dimensions, collecting capacity and collecting efficiency by dust particle size.

3. The gas turbine intake air filter selecting system as set forth in claim 1, wherein said filter use environmental data memory unit further stores data of atmospheric dust distribution by particle size and number of filters installed.

4. The gas turbine intake air filter selecting system as set forth in claim 1, wherein said actual plant data memory unit stores data of actual electric energy production, gas turbine operating time, fuel unit price, thermal efficiency, fuel calorific value, filter replacing frequency, filter discard cost and number of filters installed.

5. The gas turbine intake air filter selecting system as set forth in claim 1, wherein
said actual cost is a total of an actual filter replacement cost calculated based on filter replacing frequency, filter discard cost and number of filters installed extracted from said actual plant data memory unit and a filter unit price extracted from said catalogue data memory unit, and an actual plant operating cost calculated based on electric energy production, fuel unit price, thermal efficiency and fuel calorific value extracted from said actual plant data memory unit; and
said estimated cost is a total of an estimated filter replacement cost calculated based on said filter life span, number of filters installed, filter discard cost and gas turbine operating time extracted from said actual plant data memory unit and a filter unit price extracted from said catalogue data memory unit, and an estimated plant operating cost calculated based on electric energy production, fuel unit price, thermal efficiency and fuel calorific value extracted from said actual plant data memory unit.
